(19) United States
(12) Patent Application Publication
(10) Pub. No.: US 2026/0361345 A1
(43) Pub. Date: Nov. 12, 2026

(54) FULL DUPLEX OPERATION WITH BEAM RESTRICTIONS

(71) Applicant: InterDigital Patent Holdings, Inc., Wilmington, DE (US)

(72) Inventors: Jonghyun PARK, Syosset, NY (US); Nazli KHAN BEIGI, Longueuil (CA); Paul MARINIER, Brossard (CA); Moon IL LEE, Melville, NY (US)

(73) Assignee: InterDigital Patent Holdings, Inc., Wilmington, DE (US)

(21) Appl. No.: 19/524,131

(22) PCT Filed: Sep. 27, 2024
(86) PCT No.: PCT/US2024/048833

§ 371 Date: Mar. 27, 2026

Related U.S. Application Data
(60) Provisional application No. 63/540,894, filed on Sep. 27, 2023.
(60) Provisional application No. 63/540,899, filed on Sep. 27, 2023.
(60) Provisional application No. 63/540,897, filed on Sep. 27, 2023.

(51) Int. Cl. H04B 7/0404; H04B 7/06; H04L 5/14; H04W 72/23

(52) U.S. Cl. CPC H04B 7/0404; H04B 7/0691; H04B 7/06956; H04L 5/14; H04W 72/23

(57) ABSTRACT

A method associated with multiple WTRU panels and their use for DL Rx and/or UL Tx is disclosed. At (501), a WTRU reports on link direction uses of one or more of the WTRU's panels. At (502), the WTRU receives confirmation on the reported link direction usages. At (503), the WTRU receives configuration information indicating a first set of beams/panels indexes for DL Rx, and a second set of beams/panels indexes for UL Tx. At (504), the WTRU receives a grant that (e.g., simultaneously) indicates first and second panels, such as one for DL Rx and the other for UL Tx, on one or more symbols. At (505), the WTRU receives a DL transmission using a first beam and the first panel (e.g., Panel 1) of the first set of beam/panel indexes, and (e.g., simultaneously) transmit an UL transmission using a second beam and the second panel (e.g., Panel 3) of the second set of beam/panel indexes.

### CROSS-REFERENCE TO RELATED APPLICATIONS

This application claims the benefit of U.S. provisional application No. 63/540,897 filed Sep. 27, 2023, 63/540,894 filed Sep. 27, 2023, and 63/540,899 filed Sep. 27, 2023, all of which are incorporated herein by reference.

### BACKGROUND

In wireless systems, devices operating in the wireless system need to improvements on operating procedures to make the wireless communication more efficient. This is particularly important for devices with more than one beam/panel. Approaches to address this need are described herein.

### SUMMARY

In one or more systems, devices, and/or methods, there may be beam reference signal restrictions (e.g., forbidden beam pairs) on symbols for full duplex operation. In one or more systems, devices, and/or methods, there may be link direction management across multiple wireless transmit receive panels and dynamic panel mapping/paring for full duplex operation. In one or more systems, devices, and/or methods, there may be group-based beam reporting framework for FD-capable WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of SBFD configuration in a TDD framework.;

FIG. 3 illustrates an example of cross-link interference (CLI), inter-base station and inter WTRU;

FIG. 4 illustrates an example of multiple WTRU-panels and their usage for DL Rx and/or UL Tx;

FIG. 5 illustrates an example method for multiple WTRU-panels and their usage for DL Rx and/or UL Tx;

FIG. 6 illustrates an example process regarding beam reference signal restrictions on symbols for full duplex operation;

FIG. 7 illustrates an example process regarding link direction management across multiple WTRU panels and dynamic panel mapping/paring for full duplex operation; and

FIG. 8 illustrates an example of process of group-based reporting framework for full duplex capable WTRU.

### DETAILED DESCRIPTION

One or more of the following terms may be referred to herein: Configured grant (CG), Dynamic grant (DG), MAC control element (MAC CE), Acknowledgment (ACK), Block Error Rate (BLER), Bandwidth Part (BWP), Coherent Joint Transmission (C-JT), Cyclic Prefix (CP), Conventional OFDM (relying on cyclic prefix) (CP-OFDM), Channel Quality Indicator (CQI), Cyclic Redundancy Check (CRC), Channel State Information (CSI), Downlink Assignment Index (DAI), Downlink Control Information (DCI), Downlink (DL), Demodulation Reference Signal (DM-RS), Data Radio Bearer (DRB), Hybrid Automatic Repeat Request (HARQ), Long Term Evolution e.g. from 3GPP LTE R8 and up (LTE), Negative ACK (NACK), Multiple TRP (mTRP), Modulation and Coding Scheme (MCS), Multiple Input Multiple Output (MIMO), Non-Coherent Joint Transmission (NC-JT), New Radio (NR), Orthogonal Frequency-Division Multiplexing (OFDM), Physical Layer (PHY), Precoding Matrix Indicator (PMI), Physical Random Access Channel (PRACH), Primary Synchronization Signal (PSS), Random Access Channel (or procedure) (RACH), Random Access Response (RAR), Radio Front end (RF), Radio Link Failure (RLF), Radio Link Monitoring (RLM), Radio Network Identifier (RNTI), Radio Resource Control (RRC), Radio Resource Management (RRM), Reference Signal (RS), Reference Signal Received Power (RSRP), Received Signal Strength Indicator (RSSI), Service Data Unit (SDU), Sounding Reference Signal (SRS), Synchronization Signal (SS), Secondary Synchronization Signal (SSS), Semi-persistent scheduling (SPS), Supplemental Uplink (SUL), Transport Block (TB), Transport Block Size (TBS), Transmission/Reception Point (TRP), Uplink (UL), Ultra-Reliable and Low Latency Communications (URLLC), Wireless Local Area Networks and related technologies (IEEE 802.xx domain) (WLAN), Time Division Duplex (TDD), Cross Division Duplex (XDD), Full Duplex (FD), Half Duplex (HD), Integrated Access and Backhaul (IAB), Self-Interference (SI), Cross-Link Interference (CLI), Physical Downlink Shared Channel (PDSCH), Physical Uplink Shared Channel (PUSCH), Physical Downlink Control Channel (PDCCH), Physical Uplink Control Channel (PUCCH), Control Resource Set (CORESET), Sounding Reference Signal (SRS), User Equipment (UE), Power Control (PC), Resource Block (RB), Layer1-RSRP (L1-RSRP), CSI-RS resource indicator-RSRP (cri-RSRP), Synchronization Signal Block (SSB), Signal-to-Interference-plus-Noise Ratio (SINR), Transmission Configuration Indicator (TCI), Open Loop Power Control (OLPC), Closed Loop Power Control (CLPC), Pathloss (PL), Power Management-Maximum Power Reduction (P-MPR), Power Headroom (PH), Power Headroom Reporting (PHR), Uplink Control Information (UCI), SRS Resource Indicator (SRI), Sidelink (Side Link) (SL), and Cell-specific RS (CRS).

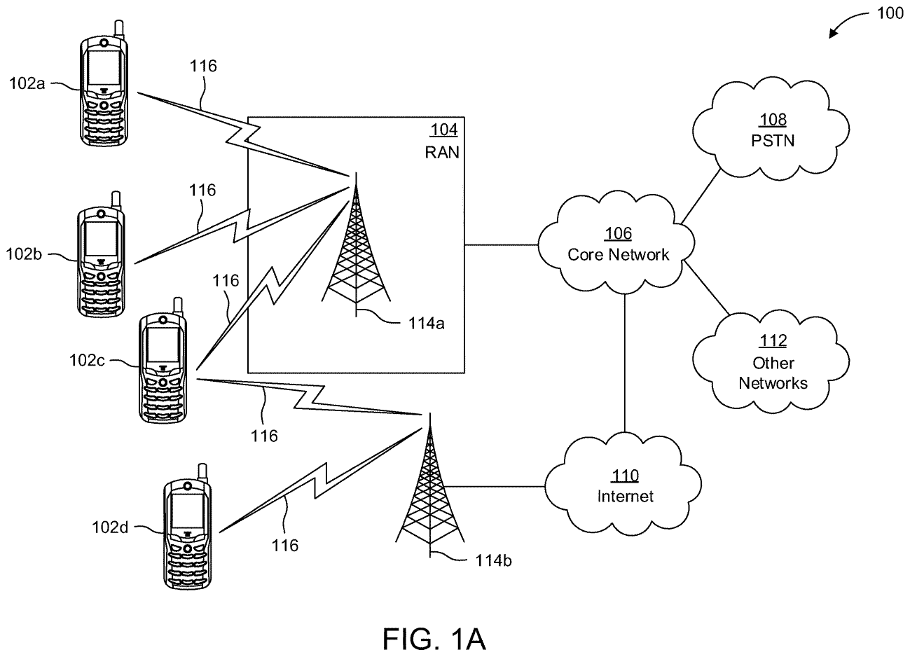

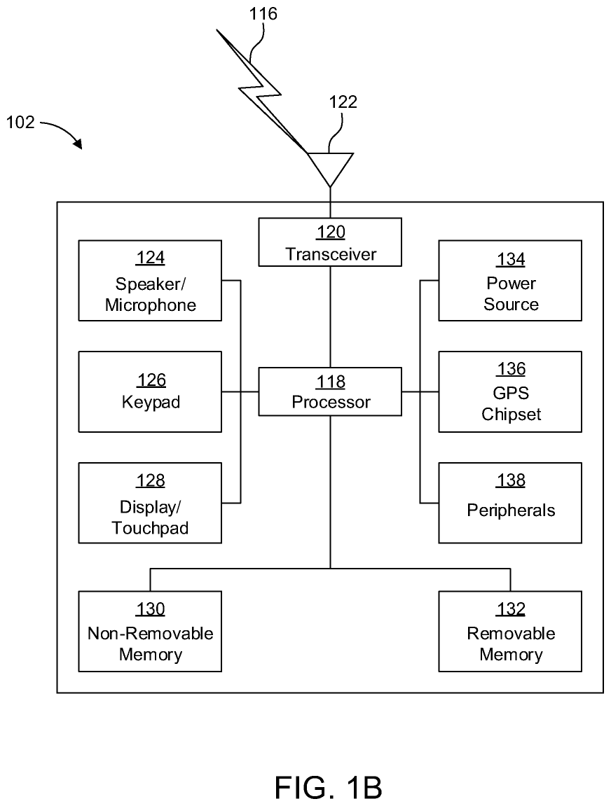

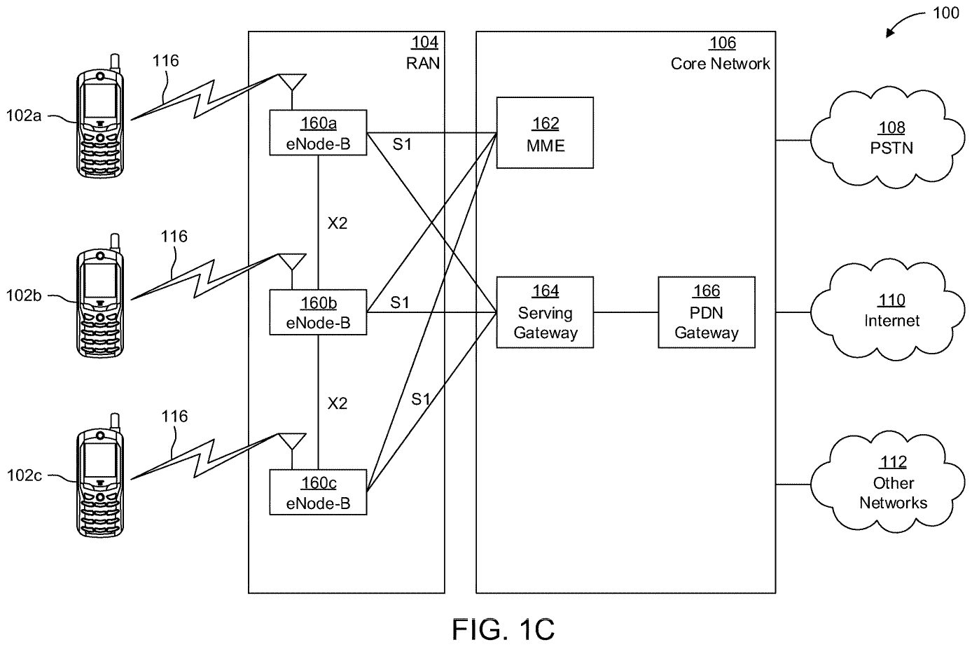

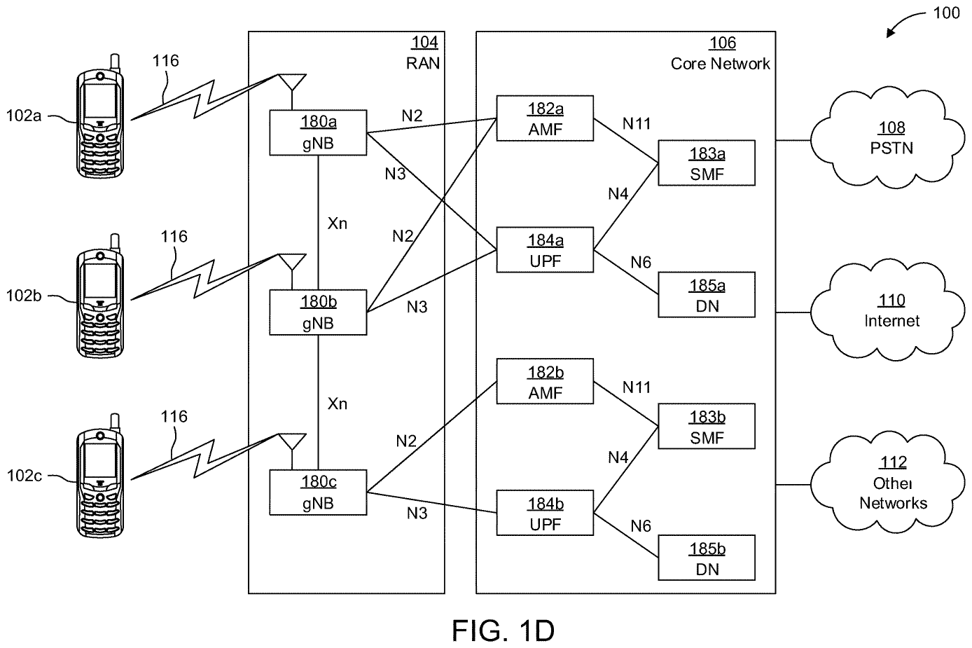

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b (and any base station reference herein) may be equivalent to or interchangeable with a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102 c, 102 d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some cases, there may be New Radio (NR) duplex operation, which may offer one or more improvements to conventional TDD operation by enhancing UL coverage, improving capacity, reducing latency, and the like. The conventional TDD is based on splitting the time domain between the uplink and downlink in a base station perspective. In one instance, there may be full duplex, or more specifically, subband non-overlapping full duplex (SBFD) at the base station within a conventional TDD band while the WTRU is operating with a half-duplex (HD).

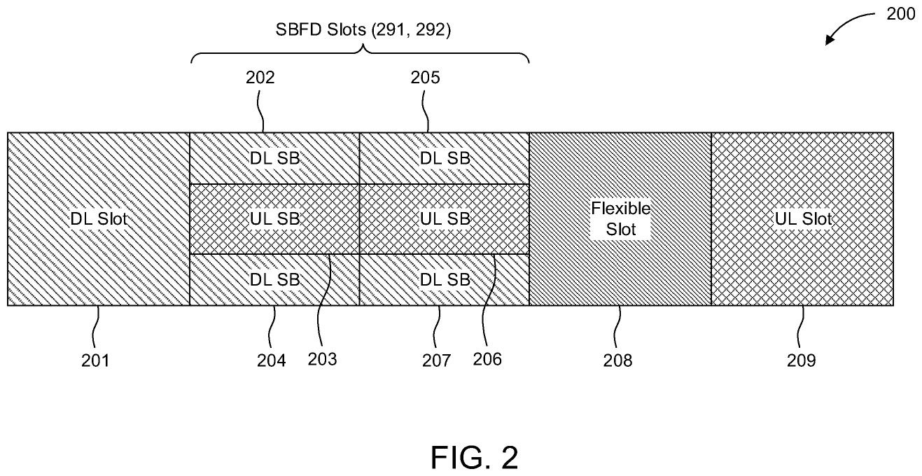

FIG. 2 illustrates an example of SBFD configuration in a TDD framework. As shown, time is shown in the horizontal axis, and there are a series of slots, where the term slot is merely illustrative and is representative of any unit of time as described herein. Immediately following a downlink slot 201, there are one or more subband non-overlapping full duplex (SBFD) slots (e.g., 291 and 292), where each slot may contain one or more subbands (SBs). In a first SBFD slot 291 there is a DL SB 202, UL SB 203, and DL SB 204. In a second SFBD slot 292 there is a DL SB 205, UL SB 206, and DL SB 207. At 208 there is a flexible slot, and at 209 there is a SL slot. The slot configuration is for illustrative purposes, and it is intended that they could be changed amongst the options shown.

Operation based on half-duplex may imply that the WTRU may either transmit a (UL) signal or receive a (DL) signal on a symbol(s), not performing simultaneously transmitting the (UL) signal and receive the (DL) signal on the same symbol(s).

The realization of SBFD may require the resolution of one or more issues raised due to cross-link interferences (CLI). In an SBFD (or dynamic/flexible TDD) framework, a potential aggressor cell may switch from UL to DL or vice-versa, causing CLI on potential victim base stations and WTRUs. In UL-to-DL CLI, the UL transmission from aggressor WTRUs may cause directional CLI at the victim WTRUS.

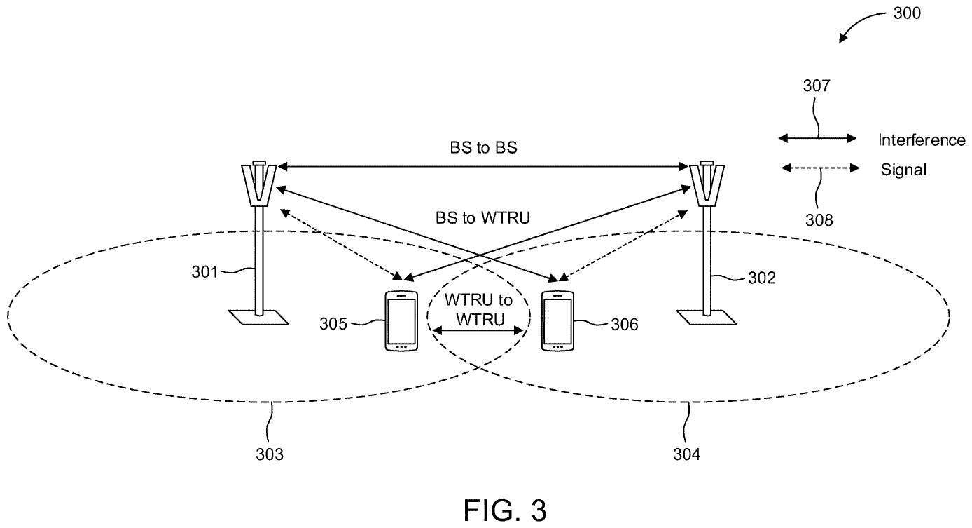

FIG. 3 illustrates an example of cross-link interference (CLI), inter-base station and inter WTRU. The CLI may be measured at both the victim and/or aggressor WTRUs. As shown, there is the signal area 303 and 304 of the gNB 301 and gNB 302, respectively, which overlap partially. WTRU 305 may communicate with any of the gNBs, or another WTRU 306. In this example, signals between WTRU 305 and gNB 302 may be interfered with by signals between WTRU 305 and gNB 301. Similarly, WTRU 306 and gNB 301 may be interfered with by signals between WTRU 306 and gNB 302. The interference is an example of cross-link interference, where the aggressor is considered interfering with the victim (e.g., in the scenarios described herein).

A WTRU, such as those described herein, that is capable of Full Duplex (FD) (e.g., SBFD, SB-overlapping FD), may efficiently manage beam/panel combinations to be used for concurrent UL and DL, when simultaneous UL Tx and DL Rx is performed on the same symbol. There may be one or more approaches to accomplishing this, such as beam reference signal restrictions (e.g., forbidden beam pairs) on symbols for FD operation, link direction management across multiple WTRU panels and dynamic panel mapping/paring for FD operation, group-based beam reporting framework for FD-capable WTRU, and/or one or more approaches that combine/subtract one or more features of the aforementioned approaches.

As described herein, the term “subband” is used to refer to a frequency-domain resource and may be characterized by at least one of the following: a set of resource blocks (RBs); a set of resource block sets (RB sets), such as when a carrier has intra-cell guard bands; a set of interlaced resource blocks; a bandwidth part, or portion thereof; and/or, a carrier, or portion thereof. For example, a subband may be characterized by a starting RB and number of RBs for a set of contiguous RBs within a bandwidth part. A subband may also be defined by the value of a frequency-domain resource allocation field and bandwidth part index.

As described herein, the term “dynamic(/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, In a system employing dynamic/flexible TDD, a component carrier(CC) or a bandwidth part (BWP) may have one single type among ‘D’, ‘U’, and ‘F’ on a symbol/slot, based on an indication by a group-common(GC)-DCI (e.g., format 2_0) comprising a slot format indicator (SFI), and/or based on tdd-UL-DL-config-common/dedicated configurations. On a given time instance/slot/symbol, a first base station (e.g., cell, TRP) employing dynamic/flexible TDD may transmit a downlink signal to a first WTRU being communicated/associated with the first base station based on a first SFI and/or tdd-UL-DL-config configured/indicated by the first base station, and a second base station (e.g., cell, TRP) employing dynamic/flexible TDD may receive an uplink signal transmitted from a second WTRU being communicated/associated with the second base station based on a second SFI and/or tdd-UL-DL-config configured/indicated by the second base station. In an example, the first WTRU may determine that the reception of the downlink signal is being interfered by the uplink signal, where the interference caused by the uplink signal may refer to a WTRU-to-WTRU cross-link interference (CLI).

As described herein, a WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or an SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such a case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

As described herein, a unified TCI (e.g., a common TCI, a common beam, a common RS, etc.) may refer to a beam/RS to be (simultaneously) used for multiple physical channels/signals. The term “TCI” may at least comprise a TCI state that includes at least one source RS to provide a reference (e.g., WTRU assumption) for determining QCL and/or spatial filter.

In an example, a WTRU may receive (e.g., from a base station) an indication of a first unified TCI to be used/applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and all or a subset of, CORESETs in a CC. In an example, a WTRU may receive (e.g., from a base station) an indication of a second unified TCI to be used/applied for both an uplink control channel (PUCCH) and an uplink shared channel (PUSCH) (e.g., and an uplink RS). The source reference signal(s) in the second unified TCI may provide a reference for determining common UL TX spatial filter(s) at least for dynamic-grant/configured-grant based PUSCH and all (or subset of) dedicated PUCCH resources in a CC.

The WTRU may be configured with a first mode for unified TCI (e.g., SeparateDLULTCI mode) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a base station) an indication of a second unified TCI to be used/applied commonly for a PDCCH, a PDSCH, a PUCCH, and a PUSCH (and a DL RS and/or a UL RS).

The WTRU may be configured with a second mode for unified TCI (e.g., JointTCI mode) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance applicable to this transmission or reception, then determining a TCI state corresponding to the Unified TCI state instance. A transmission may consist of at least PUCCH, PUSCH, and/or SRS. A reception may consist of at least PDCCH, PDSCH, and/or CSI-RS. A Unified TCI state instance may also be referred to TCI state group, TCI state process, unified TCI pool, a group of TCI states, a set of time-domain instances/stamps/slots/symbols, and/or a set of frequency-domain instances/RBs/subbands, etc. A Unified TCI state instance may be equivalent or identified to a Coreset Pool identity (e.g., CORESETPoolIndex, a TRP indicator, and/or the like).

As described herein, a unified TCI may be interchangeably used with one or more of unified TCI-states, unified TCI instance, TCI, and TCI-state, but still consistent with descriptions herein.

A TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with descriptions herein.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g., cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: CSI Report Configuration, CSI-RS Resource Set, and/or NZP CSI-RS Resources.

CSI Report Configuration may include one or more of the following: CSI report quantity, such as Channel Quality Indicator (CQI), Rank Indicator (RI), Precoding Matrix Indicator (PMI), CSI-RS Resource Indicator (CRI), Layer Indicator (LI), etc.; CSI report type, such as aperiodic, semi persistent, periodic; CSI report codebook configuration, such as Type I, Type II, Type II port selection, etc.; and/or, CSI report frequency.

CSI-RS Resource Set may include one or more of the following CSI Resource settings: NZP-CSI-RS Resource for channel measurement; NZP-CSI-RS Resource for interference measurement; and/or, CSI-IM Resource for interference measurement.

NZP CSI-RS Resources may include one or more of the following: NZP CSI-RS Resource ID; Periodicity and offset; QCL Info and TCI-state; and/or, Resource mapping, such as number of ports, density, CDM type, etc.

A WTRU may indicate, determine, or be configured with one or more reference signals. The WTRU may monitor, receive, and measure one or more parameters based on the respective reference signals. For example, such a parameter may be a SS-RSRP, CSI-RSRP, SS-SINR, CSI-SINR, RSSI, CLI-RSSI, and/or SRS-RSRP. These parameters are non-limiting examples of the parameters that may be included in reference signal(s) measurements. One or more of these parameters may be included. Other parameters may be included.

SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

Cross-link interference received signal strength indicator (CLI-RSSI) may be measured based on the average of the total power contribution in configured OFDM symbols of the configured time and frequency resources. The power contribution may be received from different resources (e.g., cross-link interference, co-channel serving and non-serving cells, adjacent channel interference, thermal noise, and so forth)

Sounding reference signals RSRP (SRS-RSRP) may be measured based on the linear average over the power contribution of the resource elements (RE) that carry the respective SRS.

A property of a grant or assignment may comprise of one or more of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or, any parameter provided in a DCI, by MAC or by RRC for the scheduling the grant or assignment.

An indication by DCI may comprise of one or more of the following: an explicit indication by a DCI field or by RNTI used to mask CRC of the PDCCH; and/or, an implicit indication by a property such as DCI format, DCI size, Coreset or search space, Aggregation Level, first resource element of the received DCI (e.g., index of first Control Channel Element), where the mapping between the property and the value may be signaled by RRC or MAC.

As described herein, a signal may be interchangeably used with one or more of following: Sounding reference signal (SRS); Channel state information-reference signal (CSI-RS); Demodulation reference signal (DM-RS); and/or, Phase tracking reference signal (PT-RS); Synchronization signal block (SSB).

As described herein, a channel may be interchangeably used with one or more of following: Physical downlink control channel (PDCCH); Physical downlink shared channel (PDSCH); Physical uplink control channel (PUCCH); Physical uplink shared channel (PUSCH); Physical random access channel (PRACH); and/or, a physical UL/DL channel associated with a transmission type.

As described herein, downlink reception may be used interchangeably with Rx occasion, PDCCH, PDSCH, SSB reception, unless otherwise indicated.

As described herein, uplink transmission may be used interchangeably with Tx occasion, PUCCH, PUSCH, PRACH, SRS transmission, unless otherwise indicated.

As described herein, RS may be interchangeably used with one or more of RS resource, RS resource set, RS port and RS port group, unless otherwise indicated.

As described herein, RS may be interchangeably used with one or more of SSB, CSI-RS, SRS and DM-RS, unless otherwise indicated.

As described herein, time instance may be interchangeably used with slot, symbol, subframe, unless otherwise indicated.

As described herein, UTCI may be interchangeably used with TCI, UTCI state, TCI state, unless otherwise indicated.

As described herein, UL-only and DL-only Tx/Rx occasions may interchangeably be used with legacy TDD UL or legacy TDD DL, respectively, unless otherwise indicated. In an example, the legacy TDD UL/DL Tx/Rx occasions may be the cases where SBFD is not configured and/or where SBFD is disabled.

As described herein, the terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably, unless otherwise indicated.

As described herein, a UL signal (e.g., at least one of SRS, DMRS, PUSCH, PUCCH, PRACH, PTRS, etc.) may be used interchangeably with a UL signal or channel, or a UL channel or signal, unless otherwise indicated.

As described herein, a DL signal (e.g., at least one of CSI-RS, SSB, PDSCH, PDCCH, PBCH, PTRS, etc.) may be used interchangeably with a DL signal or channel, or a DL channel or signal, unless otherwise indicated.

For subband non-overlapping full duplex (SBFD) operations or subband overlapping full duplex operations or full duplex operations without limiting granularity of subbands, a WTRU may be configured with one or more types of slots within a bandwidth, wherein a first type of slot may be used or determined for a first direction (e.g., downlink, or sidelink (e.g., WTRU-to-WTRU communication, device-to-device communication); a second type of slot may be used or determined for a second direction (e.g., uplink, or sidelink); a third type of slot may have a first group of frequency resources within the bandwidth for a first direction and a second group of frequency resources within the bandwidth for a second direction.

As described herein, the bandwidth may be interchangeably used with bandwidth part (BWP), carrier, subband, and system bandwidth.

As described herein, the first type of slot (e.g., the slot for a first direction) may be referred to as downlink (and/or sidelink) slot.

As described herein, the second type of slot (e.g., slot for a second direction) may be referred to as uplink (and/or sidelink) slot.

As described herein, the third type of slot may be referred to as Sub-Band (non-overlapping or overlapping) Full Duplex (SBFD) slot, such as comprising at least one of DL SB(s), UL SB(s), sidelink SB(s), guard band(s) (or RB(s), and flexible SB(s) (e.g., SB(s) that may be dynamically determined as one of DL SB(s), UL SB(s), sidelink SB(s));

As described herein, the group of frequency resource for a first direction may be referred to as downlink (and/or sidelink) subband, downlink (and/or sidelink) frequency resource, or downlink (and/or sidelink) RBs;

As described herein, the group of frequency resource for a second direction may be referred to as uplink (and/or sidelink) subband, uplink (and/or sidelink) frequency resource, or uplink (and/or sidelink) RBs.

As described herein, the group of frequency resource for a flexible direction (e.g., that can be configured for a first direction, second direction, etc.) may be referred to as flexible subband, flexible frequency resource, or flexible RBs.

As described herein, the group of frequency resource between a first direction and a second direction may be referred to as guard band, guard frequency resource, or guard RBs.

In an example, a (SBFD-enabled) WTRU may receive configuration information or be configured with one or more SBFD UL, DL, sidelink, flexible, and/or guard subbands in one or more DL/UL/flexible TDD time instances (e.g., symbols, slots, frames, and so forth). The WTRU may be configured with one or more resource allocations for SBFD subbands.

For example, the SBFD configuration may include a flag signal (e.g., enabled/disabled), where for example a first value (e.g., zero (0) indicates a first mode of operation (e.g., SBFD configuration), and a second value (e.g., one (1)) may indicate a second mode of operation (e.g., non-SBFD operation). The modes of operation (e.g., SBFD and/or non-SBFD) may be indicated via MIB, SIB, semi-statically (e.g., via RRC), dynamic (e.g., via MAC-CE, DCI), and any other type of signaling described herein. The WTRU may receive the time resources (e.g., one or more symbols, slots, and so forth), for which the first mode of operation (e.g., SBFD) is defined in for example one or more BWPs, subbands, component carriers (CC), cells, and so forth. The WTRU may receive the frequency resources (e.g., subbands/BWPs including one or more PRBs) within one or more (active and/or linked) BWP, for which the first mode of operation (e.g., SBFD) is configured. The time instances (e.g., slots, symbols) may be indicated based on periodic, semi-persistent, or aperiodic configurations. In an example, the time instances may be indicated via a bitmap configuration, where each bit corresponds to a time instance (e.g., slot, symbol, subframe, etc.) and each bit indication indicates whether a corresponding time instance can be used for the first or second mode of operation.

In some cases, there may be beam-domain “subset restrictions” where, for example, among some number of beams (e.g., 16 beams), in non-SBFD (or non-FD) symbols all 16 beams may be used, but in WTRU-SBFD (or SBFD or FD) symbols a subset of beams may be used for both DL/UL as a beam/panel combination (e.g., excluding forbidden combinations). This may further be dependent on frequency-gap between DL and UL.

In one case, a WTRU receives one or more messages that include configuration information indicating a first set of symbols that is associated with a full duplex operation (e.g., SBFD or FD or subband-overlapping FD) and a second set of symbols that is not associated with the full duplex operation (e.g., non-SBFD or non-FD).

The WTRU may receive configuration information indicating a set of DL RSs (e.g., CSI-RSs and/or SSB indexes, etc.) for measurement and reporting, such as for beam management.

The WTRU may measure and determine one or more DL RSs (e.g., RS1, RS4, RS9, RS10) that may be used in the second set of symbols (e.g., non SBFD or non-FD symbols), among the set of DL RSs, and/or report them, such as in a reporting instance based on configuration information. The determination of the one or more DL RSs may be based on the corresponding beam strength, or quality, metrics, such as (L3-)RSRP, L1-RSRP, SINR, RSRQ, etc., being greater than a threshold (e.g., where the measurements are performed in one or more symbols in the second set of symbols).

The WTRU may perform cross link interference (CLI) measurements for the determined one or more DL RS (e.g., in one or more symbols of the first set of symbols). A CLI measurement on a DL RS may comprise of one or more cases: a first CLI (CLI-Case1) is Inter-WTRU CLI measurement, where the WTRU may measure, such as using a Rx beam based on the DL RS, one or more other WTRU's transmitted signal(s) (e.g., SRS) and determine a corresponding quality metric (e.g., SRS-RSRP); a second (CLI-Case2) is self-interference (SI) measurement, where the WTRU is capable of simultaneous UL Tx and DL Rx, and the WTRU may measure, such as using a Rx beam based on the DL RS, the WTRU's transmitted UL signal(s) (e.g., SRS or other UL signals) and determine corresponding quality metric(s).

Based on the CLI measurements, the WTRU may determine at least one DL RS (e.g., RS4 and RS10), of the one or more DL RSs as having CLI above a CLI-threshold (e.g., too high CLI in the first set of symbols) and reports the at least one DL RS to the base station.

The WTRU may report the at least one DL RS, for example, with a flag(s) indicating the type of measurement is used, for example the case that is applied such as CLI-Case1 and/or CLI-Case2 (e.g., for each reported DL RS). For example, if the WTRU reports CLI-Case2 (SI) associated with a DL RS(s) of the at least one DL RS, the DL RS(s) may not be allowed (e.g., may be forbidden) to be used for DL reception on a symbol when the DL RS(s) (or an RS(s) associated/paired with the DL RS(s) such as via a TCI-state) is indicated to be used for UL transmission on the same symbol (e.g., due to the self-interference at the WTRU). Otherwise, the DL RS(s) may be used for DL reception (not forbidden) as long as no UL Tx is simultaneously scheduled on a same symbol.

The WTRU may suggest (e.g., in the report) an alternate Rx or DL beam (e.g., an alternate TCI state or alternate DL RS) to use in the first set of symbols for one or more of (e.g., each of) the at least one DL RS. The WTRU may receive confirmation or an indication from the base station on the use of the alternate Rx or DL beam for one or more of (e.g., each of) the at least one DL RS.

In an example, the WTRU may receive an indication, such as a scheduling grant, to use/apply a DL RS (e.g., RS4) of the one or more DL RSs for receiving a DL signal or channel (e.g., configured-grant (CG) PDSCH, semi-persistent-scheduling (SPS) PDSCH, etc.) in symbols of the first and/or second set of symbols.

The WTRU may receive, such as in response to the indication, the DL signal or channel using (e.g., using a Rx beam based on) the indicated DL RS (e.g., RS4) in a symbol(s) of the second set of symbols (non-FD), and receive the DL signal or channel using (e.g., using a Rx beam based on) the alternate DL beam or RS associated with the indicated DL RS (e.g., associated by the WTRU suggestion and/or base station confirmation or indication) in the symbol(s) of the first set of symbols (FD).

A WTRU may receive one or more configurations for beam RS restrictions to be applied when a full-duplex (FD) mode or operation is configured or enabled. The WTRU may receive configuration(s) indicating a first set of symbols that is associated with a FD operation (e.g., SBFD or FD or subband-overlapping FD) and a second set of symbols that is not associated with the FD operation (e.g., non-SBFD or non-FD). The WTRU may receive configuration(s) indicating a set of DL RSs (e.g., CSI-RSs and/or SSB indexes, etc.) for measurement and reporting, such as for beam management and/or cross-link interference (CLI) measurement.

The WTRU may receive configuration(s) on parameter(s) for switching time when a restricted (e.g., forbidden) DL beam is used in FD symbol. The switching time may imply that the WTRU may need more time to choose a best/alternative beam, and/or panel, on the FD symbol, on condition that a restricted (e.g., forbidden) DL beam is indicated to be applied.

The WTRU may measure (e.g., CLI measurements) and determine one or more DL RSs (e.g., candidates) (e.g., RS1, RS4, RS9, RS10) that may be used in the second set of symbols (e.g., non SBFD or non-FD symbols), among the set of DL RSs, and/or report(s) them, such as in a (beam) reporting instance based on the configuration. The determination of the one or more DL RSs may be based on the corresponding beam strength (or quality) metrics, such as (L3-)RSRP, L1-RSRP, Signal-to-interference-noise-ratio (SINR), Reference-signal-received-quality (RSRQ), etc., being greater than a threshold (e.g., where the measurements are performed in one or more symbols in the second set of symbols). The threshold may be (pre-)configured or indicated from a base station. The WTRU may receive an indication to use/apply a DL RS(s) of the one or more DL RSs for a DL reception (e.g., PDSCH reception, PDCCH monitoring, etc.) on a symbol(s) of the second set of symbols (e.g., non-FD), where the DL reception may be performed based on using a spatial-domain filter determined by the DL RS(s).

The WTRU may perform (or be configured to perform) cross link interference (CLI) measurements for the determined one or more DL RS (e.g., in one or more symbols of the first set of symbols). Alternatively, the WTRU may perform (or be configured to perform) cross link interference (CLI) measurements for (e.g., any) DL RS(s) in the set of DL RSs, such as in one or more symbols of the first set of symbols. In an example, a CLI measurement on a DL RS may comprise at least one of CLI-Case1 for Inter-WTRU CLI measurement and CLI-Case2 for Self-interference (SI) measurement. For the CLI-Case1 (e.g., inter-WTRU CLI measurement), the WTRU may measure, such as using a Rx beam based on the DL RS, one or more other WTRU's transmitted signal(s) (e.g., SRS) and determine a corresponding quality metric (e.g., SRS-RSRP). For the CLI-Case2 (e.g., SI measurement), the WTRU may measure, such as using a Rx beam based on the DL RS, the WTRU's transmitted UL signal(s) (e.g., SRS or other UL signals) and determine corresponding quality metric, such as where the WTRU may be capable of simultaneous UL Tx and DL Rx for applying the CLI-Case2.

Based on the CLI measurements, the WTRU may determine at least one DL RS (e.g., RS4 and RS10), of the one or more DL RSs as having CLI above a CLI-threshold (e.g., too high CLI in the first set of symbols) and reports the at least one DL RS to the base station. For the CLI-Case1 and/or CLI-Case2, the WTRU may perform (or be configured to perform) the CLI measurement based on assuming a frequency (e.g., RB) gap between a DL signal and a UL signal, where the WTRU may determine the at least one DL RB being forbidden by assuming the frequency gap (e.g., RB gap) between the DL signal and the UL signal is less than M RBs, where the value of M may be configured (e.g., by RRC and/or MAC-CE) from the base station and/or updated/indicated by MAC-CE or DCI.

The WTRU may report the at least one DL RS, such as with a flag(s) (or selector(s)) indicating the applied CLI-Case1 and/or CLI-Case2 (e.g., for each reported DL RS). In an example, if the WTRU reports CLI-Case2 (SI) associated with a DL RS(s) of the at least one DL RS, the DL RS(s) may not be allowed (e.g., may be forbidden) to be used for DL reception on a symbol when the DL RS(s) (or an RS(s) associated/paired with the DL RS(s) such as via a TCI-state) is indicated to be used for UL transmission on the same symbol (due to the self-interference at the WTRU). Otherwise, the DL RS(s) may be used for DL reception (not forbidden) as long as no UL Tx is simultaneously scheduled on a same symbol). The WTRU may suggest (e.g., in the report) an alternate Rx or DL beam (e.g., an alternate TCI state or alternate DL RS) to use in the first set of symbols for one or more of (e.g., each of) the at least one DL RS. The WTRU may receive confirmation or indication from the base station on the use of the alternate Rx or DL beam for one or more of (e.g., each of) the at least one DL RS.

The WTRU may receive an indication to use/apply a DL RS (e.g., RS4) of the one or more DL RSs for receiving a DL signal or channel (e.g., configured-grant (CG) PDSCH, semi-persistent-scheduling (SPS) PDSCH, etc.) in symbols of the first and/or second set of symbols. The WTRU may receive the DL signal or channel using (e.g., using a Rx beam based on) the indicated DL RS (e.g., RS4) in a symbol(s) of the second set of symbols (non-FD), and receive the DL signal or channel using (e.g., using a Rx beam based on) the alternate DL beam or RS associated with the indicated DL RS (e.g., associated by the WTRU suggestion and/or base station confirmation or indication) in the symbol(s) of the first set of symbols (FD). In an example, alternatively, the WTRU may receive the DL signal or channel using (e.g., using a Rx beam based on) the indicated DL RS (e.g., RS4) in a symbol(s) of the second set of symbols (non-FD), and skip receiving the DL signal or channel in the symbol(s) of the first set of symbols (FD).

The WTRU may determine that the DL signal or channel scheduled to be received in a symbol(s) of the first set of symbols (FD) is delayed based on the parameter(s) for switching time, such as on condition that a UL grant scheduling transmission of a UL signal or channel indicates the UL transmission on the (same) symbol(s) (or at least partially overlapped symbol(s)) of the first set of symbols (FD). In an example, the determination that the DL signal or channel is delayed may be based on determining the UL grant is received later than a DL grant scheduling the DL signal or channel. The parameter(s) for switching time may be based on WTRU capability reporting and/or confirmation or indication from the base station.

The WTRU may receive configuration indicating a set of SRS resources (e.g., for beam management) and/or a set of UL-TCI (or joint UL/DL-TCI) states. The WTRU may transmit SRSs of the set of SRS resources by applying different UL beams in the second set of symbols (non-FD). The WTRU may transmit a UL signal or channel by applying a UL-TCI state of the set of UL-TCI states in the second set of symbols (non-FD).

The WTRU may determine one or more SRSs of the set of SRS resources and/or one or more UL-TCI states of the set of UL-TCI states being restricted (e.g., forbidden) to be used in the first set of symbols (FD symbols), and/or report them to the base station. The determination of the one or more SRSs and/or the one or more UL-TCI states being restricted (e.g., forbidden) may be based on CLI measurements which may comprise at least one of the CLI-Case1 (inter-WTRU CLI measurement) and the CLI-Case2 (SI measurement).

For the CLI-Case1 for inter-WTRU CLI measurement, the WTRU may measure, by using an Rx beam of a UL-TCI state or corresponding to an SRS beam of the one or more SRSs, other WTRU's transmitted signal(s) (e.g., SRS) and determine a corresponding quality metric (e.g., SRS-RSRP), such as to avoid CLI to other potential victim WTRUs.

For the CLI-Case2 for SI measurement, the WTRU may measure, by using an Rx beam of a UL-TCI state or corresponding to an SRS beam of the one or more SRSs, the WTRU's transmitted UL signal(s) (e.g., SRS or other UL signals) and determine a corresponding quality metric, such as where the WTRU may be capable of simultaneous UL transmission and DL reception.

The WTRU may report the one or more SRSs and/or the one or more UL-TCI states along with a flag(s) (e.g., selector(s)) indicating the applied CLI-Case1 and/or CLI-Case2. If the WTRU reports CLI-Case2 associated with at least one of the one or more SRSs and/or the one or more UL-TCI states, the at least one may be restricted (e.g., forbidden) to be used for UL transmission RS(s) on a symbol when the RS(s) associated with the at least one is indicated to be used for DL reception on the same symbol (due to the self-interference at the WTRU). Otherwise, the at least one may be used for UL transmission (e.g., not forbidden as long as no DL Rx is simultaneously scheduled on a same symbol).

The WTRU may suggest (e.g., in the report) an alternate Tx or UL beam (e.g., an alternate joint/UL-TCI state or alternate UL RS) to use in the first set of symbols. The WTRU may receive confirmation or indication from the base station on the use of the alternate Tx or UL beam for one or more of (e.g., each of) the one or more SRSs and/or the one or more UL-TCI states.

The WTRU may receive an indication to use/apply an RS of the one or more SRSs and/or the one or more UL-TCI states for transmitting an UL signal (e.g., configured-grant PUSCH) across symbols of the first and second set of symbols. The UL signal may be based on multiple configured grant (CG) configurations (e.g., with different periodicity parameters, and/or different beam/TCI-state related parameters, across different CG configurations of the multiple CG configurations). For example, if more than one CG configuration overlapped with a DL Rx on a same symbol, the WTRU may choose one CG (of the multiple CG configurations) with a not-restricted (e.g., not-forbidden) beam, such as depending on the DL Rx with the beam/panel that would have collided (e.g., of the same WTRU). Another way of explaining the aforementioned is that a WTRU may select one CG (e.g., out of the multiple CGs) where the UL beam of the one CG has a good pair of a DL beam (e.g., not-forbidden beam) where the DL beam is what is being used for a DL Rx for the same WTRU.

The WTRU may transmit the UL signal by using the RS in a symbol(s) of the second set of symbols (non-FD), and the WTRU may skip transmitting the UL signal in a symbol(s) of the first set of symbols (FD) or the WTRU may transmit the UL signal by using a second RS (e.g., associated with the RS) in the symbol(s) of the first set of symbols (FD) where the second RS may be the alternate Tx or UL beam (e.g., an alternate joint/UL-TCI state or alternate UL RS) suggested by the WTRU via the reporting.

In some cases, a WTRU may report its capability information on one or more WTRU-panels (e.g., with corresponding WTRU-panel IDs), such that each of the WTRU-panels is able to be used for at least one of {DL reception, UL transmission, either DL Rx or UL Tx selectively, and both DL Rx and UL Tx simultaneously}, such as: Panel 1 is able to be used for either DL Rx or UL Tx selectively; Panel 2 is able to be used for DL reception (only); Panel 3 is able to be used for both DL Rx and UL Tx simultaneously; and/or, Panel 4 is able to be used for DL reception (only). Note, “Panel” may be referred to herein, and interchangeable with, a “beam group, or RS group” and/or a component that is a unit for independently applying power control and/or timing control. Final beam selection (within a selected panel) may be made for any DL Rx or UL Tx.

The WTRU may receive configuration (e.g., from a base station) confirming the link direction usages of the one or more WTRU-panels as the reported WTRU capability information, or indicating different/updated link direction usages (e.g., Panel 3 is only for DL reception, due to heavy DL-traffic).

The WTRU may receive configuration indicating a 1st set of beam/panel indexes (e.g., joint/DL-TCI states) for DL receptions and a 2nd set of beam/panel indexes (e.g., joint/UL-TCI states) for UL transmissions. A set of beam/panel indexes may include a set of panel indexes (e.g., 1, 2, 3, 4) and a set of beam indexes or a set of beam indexes for each panel.

The WTRU may receive a grant that indicates first and second panels, one for DL Rx and the other for UL Tx, on symbol(s). A panel index from among the 1st set of panel indexes may be indicated for DL Rx and a panel index from among the 2nd set of panel indexes may be indicated for UL Tx. The grant may also indicate an Rx beam and a Tx beam.

The WTRU may transmit an UL transmission (e.g., PUSCH, PUCCH, SRS) using the beam and/or panel indicated for UL Tx and/or receive a DL transmission (e.g., PDSCH, PDCCH, DL RS) using the beam and/or panel indicated for DL Rx. The WTRU may transmit at least part of the UL transmission and receive at least part of the DL transmission simultaneously. In an example, the grant may be for the UL transmission and the DL reception may be scheduled separately (e.g., SPS PDSCH, CSI-RS). In an example, the grant may be for the DL reception and the UL transmission may be scheduled separately (e.g., configured grant, SRS).

In one example, for an UL grant, the WTRU receives an UL grant that indicates first and second panels, one for UL Tx and the other for DL Rx. The UL grant indicates at least an UL resource assignment, a panel Y (e.g., Y=1) for the UL Tx, a panel X (e.g., X=4) for the DL Rx simultaneously on the symbol(s). A DL resource assignment for the DL Rx may not be included in the UL grant, for example, but may be included in other indication(s) or config(s) (e.g., SPS-PDSCH). The UL grant may indicate a beam y (e.g., UL-TCI, y=7) within the panel Y and/or a beam x (e.g., DL-TCI, x=11) within the panel X, such as jointly with or separately from the indications for WTRU-panels. The indicated DL beam x and/or panel X may be “beam/panel-overriding indication” and this indication may be applicable only one time (e.g., on the symbol(s)) or be applicable for a duration of time that may be configured or indicated from the base station. The WTRU transmits the UL signal or channel (the granted UL transmission) from panel Y and/or using beam y, and receives a DL signal or channel using panel X and/or beam x, such as when the UL transmission and the DL signal or channel at least partially overlap.

In one example, a DL grant, the WTRU receives a DL grant that indicates first and second panels, one for DL Rx and the other for UL Tx. The DL grant indicates at least a DL resource assignment, a panel X (e.g., X=2) for the DL Rx, a panel Y (e.g., Y=3) for the UL Tx simultaneously on the symbol(s). A UL resource assignment for the UL Tx may not be included in the DL grant, for example, but may be included in other indication or config (e.g., CG-PUSCH). The DL grant may indicate a beam x (e.g., DL-TCI, x=23) within the panel X and/or a beam y (e.g., UL-TCI, x=17) within the panel Y, such as jointly with or separately from the indications for WTRU-panels. The indicated UL beam y and/or panel Y may be “beam/panel-overriding indication” and this indication may be applicable only one time (e.g., on the symbol(s)) or be applicable for a duration of time that may be configured or indicated from the base station. The WTRU receives the DL signal or channel (the granted DL reception) using panel X and/or beam x, and transmits the UL signal from panel Y and/or using beam y, such as when the DL transmission and the UL signal or channel at least partially overlap.

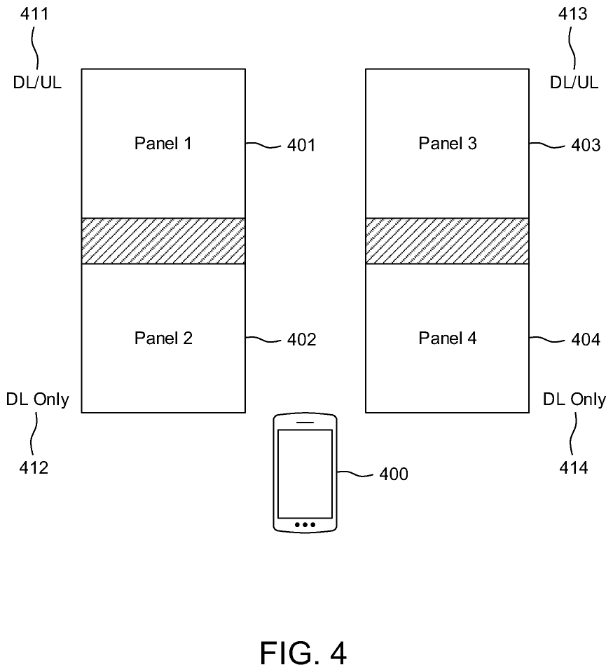

FIG. 4 illustrates an example of multiple WTRU-panels and their usage for DL Rx and/or UL Tx. The first panel 401 may be used for either DL or UL. The second panel 402 may be used for DL reception only. The third panel 403 may be used for both DL and UL simultaneously. The fourth panel 404 may be used for DL reception only.

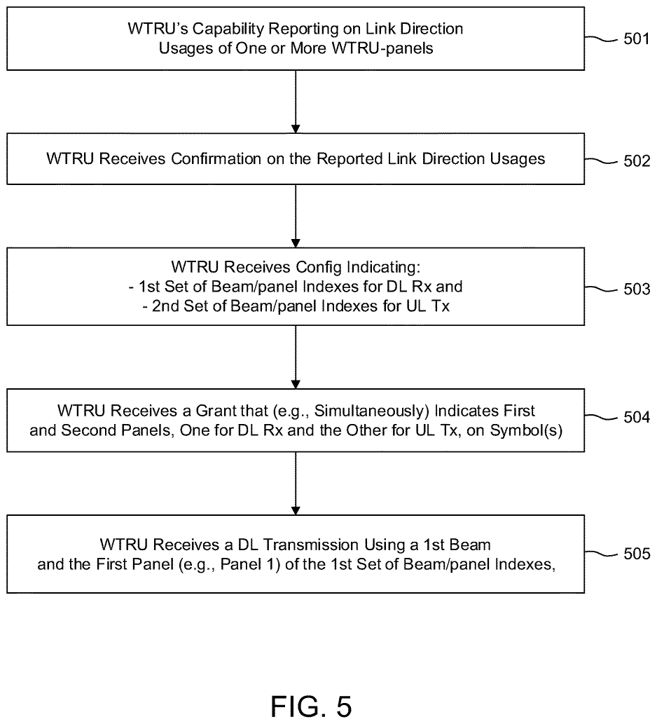

FIG. 5 illustrates an example of a method associated with multiple WTRU panels and their use for DL Rx and/or UL Tx. At 501, a WTRU may report on link direction uses of one or more of the WTRU's panels (e.g., such as illustrated in FIG. 4). At 502, the WTRU may receive confirmation on the reported link direction usages. At 503, the WTRU may receive configuration information indicating a first set of beams/panels indexes for DL Rx, and a second set of beams/panels indexes for UL Tx. At 504, the WTRU may receive a grant that (e.g., simultaneously) indicates first and second panels, such as one for DL Rx and the other for UL Tx, on one or more symbols. At 505, the WTRU may receive a DL transmission using a first beam and the first panel (e.g., Panel 1) of the first set of beam/panel indexes, and (e.g., simultaneously) transmit an UL transmission using a second beam and the second panel (e.g., Panel 3) of the second set of beam/panel indexes.

Generally, a WTRU may transmit (e.g., report) its capability information on one or more WTRU-panels (e.g., with corresponding WTRU-panel IDs), such as to a base station, such that each of the WTRU-panels is able to be used for at least one of {DL reception, UL transmission, either DL reception(Rx) or UL transmission(Tx) selectively, and both DL Rx and UL Tx simultaneously}, as illustrated in FIG. 4. A “WTRU-Panel” may be referred to as a “beam group, or RS group” and/or an entity that may be a unit for independently applying power control and/or timing control. Final beam selection (within a selected panel) may be made (and/or indicated to the WTRU) for a DL reception and/or a UL transmission.

The WTRU may transmit (e.g., report) its capability information on the one or more WTRU-panels, such as based on one or more of the following information contents: Panel 1 is able to be used for either DL Rx or UL Tx selectively; Panel 2 is able to be used for DL reception (only); Panel 3 is able to be used for both DL Rx and UL Tx simultaneously; and/or, Panel 4 is able to be used for DL reception (only).

In an example, a WTRU-panel of the one or more WTRU-panels may be able to be used for UL transmission (only), which may be reported by the WTRU as the capability information.

The WTRU capability reporting may provide benefits at least considering that the WTRU may have different spatial isolations (e.g., 60 dB for Panel 1, 80 dB for Panel 3) and/or different maximum power (e.g., Pc, max) values applicable for different panels. In addition, beam correspondence (or reciprocity) may not be assumed across different panels, such as beam(s) to be used for UL Tx from Panel 1 or 3 may not be utilized from Rx beam(s) at Panel 2 or 4, such as it/they may be based on “quasi-reciprocity” or “semi-reciprocity”, etc.

The WTRU may receive configuration (e.g., from the base station, in response to the reporting) confirming the link direction usages of the one or more WTRU-panels as the reported WTRU capability information. For example, alternatively, the WTRU may receive configuration (e.g., a message updating the link direction usages) indicating different/updated link direction usages, such as Panel 3 is only for DL reception, due to heavy DL-traffic, and so on.

The WTRU may receive configuration indicating a 1st set of beam/panel indexes (e.g., joint/DL-TCI states) for DL receptions and a 2nd set of beam/panel indexes (e.g., joint/UL-TCI states) for UL transmissions. A set of beam/panel indexes may include a set of panel indexes (e.g., 1, 2, 3, 4) and a set of beam indexes or a set of beam indexes for each panel.

The WTRU may receive a grant that indicates first and second panels, one for DL Rx and the other for UL Tx, on symbol(s). A panel index from among the 1st set of panel indexes may be indicated for DL Rx and a panel index from among the 2nd set of panel indexes may be indicated for UL Tx. The grant may also indicate an Rx beam and a Tx beam. The WTRU may transmit an UL transmission (e.g., PUSCH, PUCCH, SRS) using the beam and/or panel indicated for UL Tx and/or receive a DL transmission (e.g., PDSCH, PDCCH, DL RS) using the beam and/or panel indicated for DL Rx. The WTRU may transmit at least part of the UL transmission and receive at least part of the DL transmission simultaneously. In an example, the grant may be for the UL transmission and the DL reception may be scheduled separately (e.g., SPS PDSCH, CSI-RS). In an example, the grant may be for the DL reception and the UL transmission may be scheduled separately (e.g., configured grant, SRS).

In an example, the WTRU may receive a UL grant that indicates both panels, one for DL reception and the other for UL transmission, on the symbol(s), such as where other DL grant contents (e.g., resource assignment part) may not be included here (in the UL grant), but only DL beam/panel selection part (e.g., “beam-overriding indication”) may be indicated in the UL grant. For example, the DL resource assignment related information may be separately given to the WTRU, such as where a DL signal or channel for the DL reception may be based on semi-persistent-scheduling(SPS)-PDSCH. The WTRU may (also) receive a time-domain related parameter(s) for when and/or how long the indicated DL beam/panel selection part is to be applied for the DL signal or channel. The time-domain related parameter(s) may comprise at least one of a time offset (for when to apply) and/or a time duration (for how long to apply).

In an example, the WTRU may receive a DL grant that indicates both panels, one for DL reception and the other for UL transmission, on the symbol(s), such as where other UL grant contents (e.g., resource assignment part) may not be included here (in the DL grant), but only UL beam/panel selection part (e.g., “beam-overriding indication”) may be indicated in the DL grant. For example, the UL resource assignment related information may be separately given to the WTRU, such as where a UL signal or channel for the UL transmission may be based on CG-PUSCH. The WTRU may (also) receive a time-domain related parameter(s) for when and/or how long the indicated UL beam/panel selection part is to be applied for the UL signal or channel. The time-domain related parameter(s) may comprise at least one of a time offset (for when to apply) and/or a time duration (for how long to apply).

In an example (for a UL grant), the WTRU may receive a UL grant that indicates first and second panels, one for UL Tx and the other for DL Rx. The UL grant may indicate at least a UL resource assignment, a panel Y (e.g., Y=1) for the UL Tx, a panel X (e.g., X=4) for the DL Rx simultaneously on the symbol(s). A DL resource assignment for the DL Rx may not be comprised in the UL grant, for example, but may be comprised in other indication or config (e.g., SPS-PDSCH). The UL grant may indicate a beam y (e.g., UL-TCI, y=7) within the panel Y and/or a beam x (e.g., DL-TCI, x=11) within the panel X, such as jointly with or separately from the indications for WTRU-panels. The indicated DL beam x and/or panel X may be “beam/panel-overriding indication”, and this indication may be applicable only one time (e.g., on the symbol(s)) or be applicable for a duration of time which may be configured or indicated from the base station. The WTRU may transmit the UL signal or channel (the granted UL transmission) from panel Y and/or using beam y, and receive a DL signal or channel using panel X and/or beam x, such as when the UL transmission and the DL signal or channel at least partially overlap.

In an example (for a DL grant), the WTRU may receive a DL grant that indicates first and second panels, one for DL Rx and the other for UL Tx. The DL grant may indicate at least a DL resource assignment, a panel X (e.g., X=2) for the DL Rx, a panel Y (e.g., Y=3) for the UL Tx simultaneously on the symbol(s). A UL resource assignment for the UL Tx may not be comprised in the DL grant, for example, but may be comprised in other indication or config (e.g., CG-PUSCH). The DL grant may indicate a beam x (e.g., DL-TCI, x=23) within the panel X and/or a beam y (e.g., UL-TCI, x=17) within the panel Y, such as jointly with or separately from the indications for WTRU-panels. The indicated UL beam y and/or panel Y may be “beam/panel-overriding indication”, and this indication may be applicable only one time (e.g., on the symbol(s)) or be applicable for a duration of time which may be configured or indicated from the base station. The WTRU may receive the DL signal or channel (the granted DL reception) using panel X and/or beam x, and transmits the UL signal from panel Y and/or using beam y, such as when the DL transmission and the UL signal or channel at least partially overlap.

In an example, the WTRU may receive a DL grant where the WTRU determines to use a panel X (e.g., X=2) to receive a DL channel or signal scheduled by the DL grant, on a symbol. On the same symbol, the WTRU may (e.g., be scheduled to) transmit a UL channel or signal (e.g., based on CG-PUSCH) from panel Y (e.g., Y=1) which may be determined based on a (pre-)association (e.g., given to the WTRU) from the panel X (e.g., X=2) for being used for a DL reception, while simultaneously receiving the DL channel or signal using the determined panel X=2. In another example, the WTRU may receive, such as prior to the DL grant, information on a pre-association between the panel X=2 for DL reception and the panel Y=3 for UL transmission, such as a paired-panel combination related information. Based on the information on the pre-association, the WTRU may transmit the UL channel or signal from panel Y=3, while simultaneously receiving the DL channel or signal using panel X=2.

Configuration or indication on the information on such one or more pre-association(s) between panel X for DL Rx and panel Y for UL Tx may provide benefits in terms of at least network-wide UL interference controls (e.g., for pairing a panel Y that causes least UL interference to nearby WTRUs at least in the beam direction perspective).

In another example, the WTRU may receive a UL grant where the WTRU determines to use a panel Y (e.g., Y=1) to transmit a UL channel or signal scheduled by the UL grant, on a symbol. On the same symbol, the WTRU may (e.g., be scheduled to) receive a DL channel or signal (e.g., based on SPS-PDSCH) from panel X (e.g., X=4) which may be determined based on a (pre-)association (e.g., given to the WTRU) from the panel Y (e.g., Y=1) for being used for a UL transmission, while simultaneously transmitting the UL channel or signal using the determined panel Y=1. In another example, the WTRU may receive, such as prior to the UL grant, information on a pre-association between the panel Y=1 for UL transmission and the panel X=3 for DL reception, such as a paired-panel combination related information. Based on the information on the pre-association, the WTRU may transmit the UL channel or signal from panel Y=1, while simultaneously receiving the DL channel or signal using panel X=3.

The WTRU may receive an (additional) indication or configuration, indicating which direction (DL or UL) is to be determined first (e.g., panel X first or panel Y first) and then the pre-associated panel for another direction (UL or DL) is to be determined. The determination on which direction (DL or UL) is to be determined first may be based on a parameter(s) related to a priority between DL and UL. For example, a dynamic grant may have higher priority than a configured grant (CG) type of grant. In another example, the determination may be based on DCI-reception timing of either DL-grant or UL-grant. For example, if a DL grant is received later than an UL grant, a first determination on panel X for DL reception based on the DL grant may be performed first, and a second determination on panel Y for UL transmission based on the UL grant may be performed based on the first determination and the pre-association, or vice-versa. For example, if a UL grant is received later than a DL grant, a first determination on panel Y for UL transmission based on the UL grant may be performed first, and a second determination on panel X for DL reception based on the DL grant may be performed based on the first determination and the pre-association, or vice-versa.

In some cases, a WTRU may select and report two, or more, beam indexes, one for DL Rx and another for UL Tx simultaneously on a FD symbol (e.g., SBFD symbol or SB overlapping FD symbol). Those two beams may be used for distinct SB, or partially/fully overlapped symbols.

A WTRU may receive configuration indicating a 1st set of beam indexes (e.g., joint/DL-TCI states) for DL receptions, a 2nd set of beam indexes (e.g., joint/UL-TCI states) for UL transmissions, and a group-based beam reporting config. A beam index may be represented by at least one of a TCI-state, a DL-TCI state, a UL-TCI state, a joint DL/UL-TCI state, an RS, a beam ID, etc. The 1st and 2nd sets may include one or more overlapped beam indexes. The group-based beam reporting config may indicate to report up to Q best/preferred UL/DL beam combinations, where the value of Q may be configured or indicated from a base station.

For each of one or more beam indexes in the first set of beam indexes, the WTRU may measure a respective DL RS and interference. The measurement may be L1-RSRP. The interference may be based on a CSI-IM resource.

For each of one or more beam indexes in the second set of beam indexes, the WTRU measure a respective DL RS. The measurement may be L1-RSRP.

The WTRU may determine a quality metric for one or more pairs of beam indexes (one from the first set (DL) and one from the second set (UL)) and selects and reports up to Q of them (e.g., the ones with the best quality metrics). In an example, the quality metric for a pair {UL index i, DL index j} is SINR determined as: SINR (ULi, DLj)=Dlj L1-RSRP/(DLj interference+w*ULi L1-RSRP), where w is a weighting coefficient, such as 0<=w<=1, which may be configured or indicated from the base station. The default value of w may be set to 1, such as on condition that the group-based beam reporting config is received (enabled) at the WTRU. ULi L1-RSRP may be determined as an L1-RSRP based on a DL RS associated with the ULi (e.g., via beam correspondence).

The WTRU may report up to Q of the pairs of beam indexes each with corresponding quality metric (e.g., the SINR (ULi, DLj)), such as where the determination of the up to Q of the pairs is based on the best quality metrics of them.

Based on the reporting, the WTRU may receive an indication (e.g., UL/DL grant, CG, SPS, etc.) to simultaneously transmit a UL signal (e.g., using ULi) and receive a DL signal (e.g., using DLj), and the WTRU may transmit the UL signal using ULi and simultaneously receives the DL signal using DLj.

In one example, when Q=4 is configured/indicated, a WTRU reports up to 4 combinations of {UL beam(RS, TCI), DL beam(RS, TCI)} along with quality metric(s), such as reports {UL5, DL7} with SINR #1, {UL3, DL11} with SINR #2, {UL8, DL2} with SINR #3, {UL17, DL2} with SINR #4. The WTRU determines a value of SINR #1 as DL7 L1-RSRP divided by (a measured interference (e.g., based on a CSI-IM resource) plus w*UL5 L1-RSRP), where in this example w=1 is applied, and UL5 L1-RSRP may be a determined L1-RSRP based on a DL RS associated with the UL5 (e.g., via beam correspondence). The WTRU may receive configuration (e.g., additional configuration) to fix (e.g., keep constant) at least one UL beam (or at least one DL beam) for the reporting. Such as WTRU reports {UL8, DL1}, {UL8, DL2}, {UL8, DL9}, and the like. Based on the reporting, the WTRU may receive an indication (e.g., UL/DL grant, CG, SPS, etc.) to simultaneously transmit a UL signal (e.g., using UL8) and receive a DL signal (e.g., using DL2), and the WTRU transmits the UL signal using UL8 and simultaneously receives the DL signal using DL2.

A WTRU may receive one or more report configurations for one or more group-based beam and/or panel indexes. For example, the WTRU may receive one or more CSI report configurations for the configured group-based beam and/or panel indexes, and the group-based beam and/or panel indexes may include one or more UL or DL beam and/or panel indexes.

A WTRU may receive report configuration information including a first set of beam and/or panel indexes for DL receptions, where the configured beam and/or panel indexes may be based on one or more joint and/or DL TCI states. The WTRU may receive report configuration information including a second set of beam and/or panel indexes for UL transmissions, where the configured beam and/or panel indexes may be based on one or more joint and/or UL TCI states. In an example, the beam and/or panel indexes in the first and second configured sets may be mutually exclusive. In another example, the first and second sets may include one or more similar, overlapped, and/or correlated beam and/or panel indexes.

Herein, the term joint TCI state may be used interchangeably with joint DL/UL-TCI state, where for example, the same TCI state may be used for both UL transmission and DL reception, but still consistent with an embodiment.

Herein, a beam index and/or a panel index may comprise of a TCI-state, a DL-TCI state, an UL-TCI state, a joint DL/UL-TCI state, a reference signal (RS) (e.g., SRS, CSR-RS, DMRS, etc.), a beam ID, and so forth.

For group-based beam/panel reporting modes, a WTRU may receive report configurations or be configured to report one or more best and/or preferred group-based beam and/or panel pair combination indexes. In an example, the WTRU may be configured to report up to Q (e.g., (pre) configured value) best and/or preferred group-based beam and/or panel pair combination indexes.

Mode 1 may be simultaneous DL Rx and UL Tx beam and/or panel index reporting, without frequency overlap.

For group-based beam/panel report configurations, a WTRU may receive configurations or be configured to report one or more best or preferred UL and DL beam and/or panel pair indexes and/or corresponding quality parameters for simultaneous UL transmission and DL reception, where the frequency resources configured for the configured and/or scheduled UL transmission have no overlap with the frequency resources configured for the configured and/or scheduled DL reception. The WTRU may receive the configurations to report the best and/or preferred UL and DL beam and/or panel indexes from the first and second configured set or beam and/or panel indexes, respectively. In an example, the WTRU may be configured, indicated, and/or determine that there is a frequency gap between the frequency resources configured for the configured and/or scheduled UL transmission and DL reception. For example, the WTRU may be configured, indicated and/or determine that there is at least X RBs (e.g., (pre)configured or indicated value) separation between the configured frequency resources for the configured and/or scheduled UL transmission and DL reception. In an example, the value of X may be reported as WTRU-capability and/or configured and/or indicated by the base station.

In an example, for a configured value of Q (e.g., Q is four), the WTRU may report up to Q best and/or preferred combination pairs of {UL beam and/or panel index, DL beam and/or panel index}. For example, the WTRU may report up to Q best and/or preferred combination pairs of {UL RS index, DL RS index}; the WTRU may report up to Q best and/or preferred combination pairs of {UL TCI state, DL TCI state}; and so forth.

In another example, for a configured value of Q (e.g., Q is four), the WTRU may report up to Q best and/or preferred combination pairs of UL and DL beam and/or panel indexes, in addition to one or more measured, calculated, and/or determined quality parameters. For example, the WTRU may report up to Q best and/or preferred combination pairs and corresponding measured and/or calculated SINR values as the quality parameters. In an example, the WTRU may report a first, second, third, up to Q best and/or preferred combination pairs of UL and DL beam and/or panel indexes in addition to the first, second, third, up to Q-th calculated and/or measured SINR value (e.g., WTRU may report (UL5, DL7) with SINR #1, (UL3, DL11) with SINR #2, (UL8, DL2) with SINR #3, (UL17, DL2) with SINR #4, and so forth).

A WTRU may calculate and/or determine the SINR of a first pair of UL and DL beam and/or panel indexes. For example, the WTRU may measure, calculate, and/or determine the numerator and the denominator to be used for calculating the SINR by dividing the measured, calculated, and/or determined numerator by the measured, calculated, and/or determined denominator. In an example, the WTRU may determine the numerator based on a first measured RSRP (e.g., L1-RSRP). For instance, the WTRU may measure the first measured RSRP based on one or more received RS (e.g., SSB, CSI-RS, etc.) that is associated with the determined DL beam and/or panel index in the first pair of UL and DL beam and/or panel indexes.

In another example, the WTRU may calculate and/or determine the denominator based on a measured interference RSSI, for example based on one or more configured or indicated CSI-interference-measurement (CSI-IM) resources (and/or CLI-RSSI resource, etc.), in addition to a modified version of a second measured RSRP (e.g., L1-RSRP). For instance, the WTRU may measure the second measured RSRP based on one or more received RS (e.g., SSB, CSI-RS, etc.) that is associated with the determined UL beam and/or panel index in the first pair of UL and DL beam and/or panel indexes. For example, the WTRU may determine the received DL RSs that are associated with the determined UL beam and/or panel index based on beam correspondence.

For example, the WTRU may use a function to derive the modified or biased version of the second measured RSRP, where the function may be pre-defined, pre-configured, or determined based on one or more parameters, for example the frequency gap (e.g., X RBs) between the DL and UL frequency resources. In an example, the function may be or may use addition. In another example, the function may be based on weighting. For example, the WTRU may add the modified or biased version of the measured second RSRP to the first measured RSSI into the denominator part of the SINR. In an example, the SINR denominator may be calculated based on the function that may be: RSSI+Weight1*second RSRP. In an example, the quality metric (e.g., the SINR) for a pair {UL index i, DL index j} may be determined, by assuming the X RB frequency gap, as SINR (ULi, DLj)=Dlj L1-RSRP/(DLj interference+w*ULi L1-RSRP), where w (e.g., the Weight1) may be a weighting coefficient, such as 0<=w<=1, which may be configured or indicated from the base station. The default value of w may be set to 1, such as on condition that the group-based beam reporting config is received (enabled) at the WTRU. The value of w may be set to 0, such as on condition that the group-based beam reporting config is released (e.g., disabled) at the WTRU. ULi L1-RSRP may be determined as an L1-RSRP based on a DL RS associated with the ULi (e.g., via beam correspondence).

Mode 2 may be simultaneous DL Rx and UL Tx beam and/or panel index reporting, with frequency overlap.

A WTRU may receive configurations or be configured to report one or more best or preferred UL and DL beam and/or panel pair indexes and/or corresponding quality parameters for simultaneous UL transmission and DL reception, where the frequency resources configured for the configured and/or scheduled UL transmission may partially or fully overlap with the frequency resources configured for the configured and/or scheduled DL reception. The WTRU may receive the configurations to report the best and/or preferred UL and DL beam and/or panel indexes from the first and second configured set or beam and/or panel indexes, respectively. In an example, the WTRU may be configured, indicated, and/or determine that there is an overlap of Y RBs (e.g., (pre)configured or indicated value) between the frequency resources configured for the configured and/or scheduled UL transmission and DL reception. In an example, the value of Y may be reported as WTRU-capability and/or configured and/or indicated by the base station.

In an example, for a configured value of Q (e.g., Q is four), the WTRU may report up to Q best and/or preferred combination pairs of {UL beam and/or panel index, DL beam and/or panel index}. For example, the WTRU may report up to Q best and/or preferred combination pairs of {UL RS index, DL RS index}; the WTRU may report up to Q best and/or preferred combination pairs of {UL TCI state, DL TCI state}; and so forth.

In another example, for a configured value of Q (e.g., Q is four), the WTRU may report up to Q best and/or preferred combination pairs of UL and DL beam and/or panel indexes, in addition to one or more measured, calculated, and/or determined quality parameters. For example, the WTRU may report up to Q best and/or preferred combination pairs and corresponding measured and/or calculated SINR values as the quality parameters. In an example, the WTRU may report a first, second, third, up to Q best and/or preferred combination pairs of UL and DL beam and/or panel indexes in addition to the first, second, third, up to Q-th calculated and/or measured SINR value (e.g., WTRU may report (UL13, DL1) with SINR #1, (UL8, DL2) with SINR #2, and so forth).

A WTRU may calculate and/or determine the SINR of a first pair of UL and DL beam and/or panel indexes. For example, the WTRU may measure, calculate, and/or determine the numerator and the denominator to be used for calculating the SINR by dividing the measured, calculated, and/or determined numerator by the measured, calculated, and/or determined denominator. In an example, the WTRU may determine the numerator based on a first measured RSRP (e.g., L1-RSRP). For instance, the WTRU may measure the first measured RSRP based on one or more received RS (e.g., SSB, CSI-RS, etc.) that is associated with the determined DL beam and/or panel index in the first pair of UL and DL beam and/or panel indexes.

In another example, the WTRU may calculate and/or determine the denominator based on a measured interference RSSI, for example based on one or more configured or indicated CSI-IM resources (and/or CLI-RSSI resource, etc.), in addition to a modified version of a second measured RSRP (e.g., L1-RSRP). For instance, the WTRU may measure the second measured RSRP based on one or more received RS (e.g., SSB, CSI-RS, etc.) that is associated with the determined UL beam and/or panel index in the first pair of UL and DL beam and/or panel indexes. For example, the WTRU may determine the received DL RSs that are associated with the determined UL beam and/or panel index based on beam correspondence.

For example, the WTRU may use a function to derive the modified or biased version of the second measured RSRP, where the function may be pre-defined, pre-configured, or determined based on one or more parameters, for example the frequency overlap (e.g., Y RBs) between the DL and UL frequency resources. In an example, the function may be or may use addition. In another example, the function may be based on weighting. For example, the WTRU may add the modified or biased version of the measured second RSRP to the first measured RSSI into the denominator part of the SINR. In an example, the SINR denominator may be calculated based on the function that may be: RSSI+Weight1*second RSRP. In an example, the quality metric (e.g., the SINR) for a pair {UL index i, DL index j} may be determined, by assuming the Y RB frequency overlap, as SINR (ULi, DLj)=Dlj L1-RSRP/(DLj interference+w*ULi L1-RSRP), where w (e.g., the Weight1) may be a weighting coefficient, such as 0<=w <=1, which may be configured or indicated from the base station. The default value of w may be set to 1, such as on condition that the group-based beam reporting config is received (enabled) at the WTRU. The value of w may be set to 0, such as on condition that the group-based beam reporting config is released (e.g., disabled) at the WTRU. ULi L1-RSRP may be determined as an L1-RSRP based on a DL RS associated with the ULi (e.g., via beam correspondence).

For Beam Quality Metric for Mode 1 and/or Mode 2, a WTRU may determine the quality parameters for one or more best or preferred UL and DL beam and/or panel pair indexes for simultaneous UL transmission and DL reception based on one or more indicated, configured, and/or determined UL power levels. For example, the WTRU may determine and/or calculate SINR (e.g., L1-SINR) as the quality parameter. In an example, the WTRU may use the calculated and/or determined UL power level to determine the denominator of the SINR. In another example, the WTRU may use the output of a function that is based on the UL power level to determine the denominator of the SINR. For example, the WTRU may determine the UL power level, based on one or more of the following: most recent configured and/or determined power level; pre-configured and/or determined power level; normalized and/or averaged power level; and/or, recent reported power headroom report (PHR) value.

For example, the most recent configured and/or determined power level is where the WTRU may use the power level that may be currently used or may have been determined, indicated, and/or configured by the most recent indication and/or configuration as the power-controlled power level. In an example, the most recent power-controlled power level may be received via an indication and/or configuration from a base station.

For example, for a pre-configured and/or determined power level is where the WTRU may use the power level that may be determined and/or (pre)configured as the power-controlled power level.

For example, normalized and/or averaged power level is where the WTRU may use the power level that may be calculated based on a normalized and/or averaged value, for example among one or more configured and/or scheduled UL channels and signals. In an example, the WTRU may calculate the normalized and/or averaged value based on one or more power level values that may be configured for one or more of the scheduled and/or configured PUSCH, PUCCH, SRS, and so forth, such as by averaging (or weighted averaging) of at least one of a first power level determined based on PUSCH power control formula/process, a second power level determined based on PUCCH power control formula/process, and/or a third power level determined based on SRS power control formula/process. The WTRU may receive one or more higher layer configuration information (e.g., RRC, MAC-CE, DCI) on the UL channels and/or signals to be used in addition to the function to be used for calculating the normalized and/or averaged power level value.

For example, recent reported power headroom report (PHR) value is where the WTRU may use the power level that may be calculated based on the recently reported PHR. In an example, the WTRU may be (pre)configured or receive one or more higher layer configuration information (e.g., RRC, MAC-CE, DCI) on the function to be used for calculating the power level value based on the PHR.

In addition, the WTRU may be configured or receive one or more configuration information to consider at least one of the UL beams to be fixed (e.g., pre-selected) during measuring and reporting one or more of the configured quality parameters for the configured and/or determined beam and/or panel pairs. Alternatively, the WTRU may be configured or receive one or more configuration information to consider at least one of the DL beams to be fixed (e.g., pre-selected) during measuring and reporting one or more of the configured quality parameters for the configured and/or determined beam and/or panel pairs. For example, the WTRU may be configured to report one or more quality parameters for one or more beam and/or panel pairs, where for example the pairs include (UL8, DL1), (UL8, DL2), (UL8, DL9), . . . , in which the UL beam (UL8) is fixed (e.g., pre-selected and not changed in determining a paired DL beam).

Based on the reporting, the WTRU may receive one or more configured grants and or indications to simultaneously transmit a UL signal (e.g., using UL8) and receive a DL signal (e.g., using DL2). Therefore, the WTRU may transmit the UL signal using UL8 and simultaneously may receive the DL signal using DL2. In an example, the WTRU may receive the configurations and/or indications regarding UL transmission and DL reception via UL grant, DL grant, configured UL grant, SPS PDSCH configuration, etc., such as via DCI, MAC-CE, RRC, etc.

A WTRU may receive one or more configuration information and/or indications (e.g., via RRC, MAC-CE, and/or DCI) to simultaneously transmit an UL transmission and receive a DL reception. For example, the WTRU may receive the indication via one or more of the UL grant, DL grant, configured UL grant, SPS PDSCH configuration, etc. In an example, the WTRU may receive an indication to transmit the scheduled and/or configured UL transmission, such as using UL8, and receive the scheduled and/or configured DL reception, such as using DL2. The WTRU may be configured to perform one or more channel and/or interference measurements based on the simultaneous configured and/or scheduled UL transmission and DL reception channels and/or signals. The WTRU may be configured or receive configuration information on one or more NZP CSI-RS resources to measure one or more channel quality measurements (e.g., RSRP). The WTRU may be configured or receive configurations on one or more CSI-IM resources to perform interference measurements.

A WTRU may receive one or more configuration information and/or indications (e.g., via RRC, MAC-CE, and/or DCI) to simultaneously transmit an UL reference signal (RS) transmission and perform channel and interference measurement. In an example, the WTRU may be configured or receive configurations to simultaneously transmit SRS and perform channel and interference measurements. For example, the WTRU may be configured to transmit SRS in the UL frequency resources (e.g., UL RBs, UL subbands, etc.) and perform measurements in DL frequency resources (e.g., DL RBs, DL subbands, etc.). The WTRU may be configured or receive configuration information on one or more NZP CSI-RS resources to measure one or more channel quality measurements (e.g., RSRP). The WTRU may be configured or receive configurations on one or more CSI-IM resources to perform interference measurements.

Mode 3 may be simultaneous DL Rx beam and/or panel indexes reporting.

A WTRU may receive configurations or be configured to report one or more best or preferred DL beam and/or panel pair indexes and/or corresponding quality parameters for simultaneous DL receptions. The WTRU may receive the configurations to report the best and/or preferred DL beam and/or panel indexes from the first configured set or beam and/panel indexes. In an example, for a configured value of Q, the WTRU may report up to Q best and/or preferred DL beam and/or panel indexes. For example, the WTRU may report up to Q best and/or preferred DL RS indexes; the WTRU may report up to Q best and/or preferred DL TCI states; and so forth.

In an example, for a configured value of Q (e.g., Q is two), the WTRU may report up to Q best and/or preferred DL beam and/or panel index and corresponding measured RSRP values. For example, the WTRU may report a first, a second, up to Q best and/or preferred DL beam and/or panel indexes in addition to the first, second, up to Q-th measured RSRP value (e.g., WTRU may report DL7 with RSRP #1, DL11 with RSRP #2, and so forth).

Based on the reporting, the WTRU may receive one or more configurations and/or indications to simultaneously receive a first DL signal (e.g., using DL7) and a second DL signal (e.g., using DL11). In an example, the WTRU may receive the configurations and/or indications via DL grants, SPS configurations, etc., such as via DCI, MAC-CE, RRC, etc. As such, the WTRU may simultaneously receive the first DL signal using DL7 and the second DL signal using DL1.

Mode 4 may be simultaneous UL Tx beam and/or panel indexes reporting.

A WTRU may receive configurations or be configured to report one or more best or preferred UL beam and/or panel pair indexes and/or corresponding quality parameters for simultaneous UL transmissions. The WTRU may receive the configurations to report the best and/or preferred UL beam and/or panel indexes from the second configured set or beam and/panel indexes. In an example, for a configured value of Q, the WTRU may report up to Q best and/or preferred UL beam and/or panel indexes. For example, the WTRU may report up to Q best and/or preferred UL RS indexes; the WTRU may report up to Q best and/or preferred UL TCI states; and so forth.

In an example, for a configured value of Q (e.g., Q is two), the WTRU may report up to Q best and/or preferred UL beam and/or panel index and corresponding measured RSRP values. For example, the WTRU may report a first, a second, up to Q best and/or preferred UL beam and/or panel indexes in addition to the first, second, up to Q-th measured RSRP value (e.g., WTRU may report UL5 with RSRP #1, UL9 with RSRP #2, and so forth).

For instance, the WTRU may report the RSRP corresponding to the UL beam and/pr panel indexes based on measured RSRP based on one or more received DL RSs (e.g., SSB, CSI-RS, etc.) that is associated to the determined UL beam and/or panel index. For example, the WTRU may determine the received DL RSs that are associated with the determined UL beam and/or panel index based on beam correspondence.

Based on the reporting, the WTRU may receive one or more configurations and/or indications to simultaneously transmit a first UL signal (e.g., using UL5) and a second UL signal (e.g., using UL9). In an example, the WTRU may receive the configurations and/or indications via DL grants, SPS configurations, etc., such as via DCI, MAC-CE, RRC, etc. As such, the WTRU simultaneously transmits the first UL signal using UL5 and the second UL signal using UL9.

For reporting configurations based on reporting modes, a WTRU may determine and report one or more best or preferred UL and DL beam and/or panel pair indexes and/or corresponding quality parameters for simultaneous UL transmission and DL reception. In an example, the WTRU may report up to Z pairs, where the value of Z may be reported as WTRU-capability and/or configured and/or indicated from a base station.

The WTRU may report one or more quality parameters for the reported best or preferred UL and DL beam and/or panel pair indexes. The WTRU may report at least one of the following is reported for one or more of the reported DL beam and/or panel indexes and at least one of the reported UL beam and/or panel indexes: {DL-RSRP, UL-RSRP}; {DL-SINR, UL-RSRP}; and/or, {DL-CQI, UL-RSRP}.

{DL-RSRP, UL-RSRP}, for example, is where the WTRU may report the measured DL-RSRP (e.g., L3-RSRP, L1-RSRP) corresponding to the reported DL beam and/or panel index. In another example, the WTRU may report the measured RSRP (e.g., L3-RSRP, L1-RSRP) corresponding to the reported UL beam and/or panel index, where the measured RSRP may be based on a DL RS that is associated with the reported the UL beam and/or panel index. For example, the WTRU may determine the DL RSs that are associated with the reported UL beam and/or panel index based on beam correspondence.

{DL-SINR, UL-RSRP}, for example, is where the WTRU may report the measured DL-SINR corresponding to the reported DL beam and/or panel index. In another example, the WTRU may report the measured RSRP (e.g., L3-RSRP, L1-RSRP) corresponding to the reported UL beam and/or panel index, where the measured RSRP may be based on a DL RS that is associated with the reported the UL beam and/or panel index. For example, the WTRU may determine the DL RSs that are associated with the reported UL beam and/or panel index based on beam correspondence.

{DL-CQI, UL-RSRP}, for example, is where the WTRU may report the measured DL-CQI corresponding to the reported DL beam and/or panel index. In another example, the WTRU may report the measured RSRP (e.g., L3-RSRP, L1-RSRP) corresponding to the reported UL beam and/or panel index, where the measured RSRP may be based on a DL RS that is associated with the reported the UL beam and/or panel index. For example, the WTRU may determine the DL RSs that are associated with the reported UL beam and/or panel index based on beam correspondence.

A WTRU may receive one or more indications and/or configuration information on one or more reporting modes, where the WTRU may apply the configured one or more reporting modes in a single reporting instance. In an example, the WTRU may be configured with one or more reporting modes including Mode 1, 2, 3, and/or 4. For example, the WTRU may receive the indication and/or configurations on the reporting modes via RRC, MAC-CE, DCI, etc. The WTRU may determine, receive configurations, or be (pre)configured to transmit the report with different contents based on the configured reporting modes.

The WTRU may receive one or more CSI report configurations for the configured group-based beam and/or panel indexes (e.g., with a selector configured or indicated from a base station that selects or enables at least one mode among the Mode 1, 2, 3, and 4), where the group-based beam and/or panel indexes may include one or more UL or DL beam and/or panel indexes. Alternatively, the WTRU may receive separate signaling based on new types of resource configurations for reporting the group-based beam and/or panel indexes (e.g., with a selector configured or indicated from a base station that selects or enables at least one mode among the Mode 1, 2, 3, and 4). The new signaling may include the UL beam and/or panel candidate resources in addition to one or more enabling parameters for the reporting modes and FD operations.

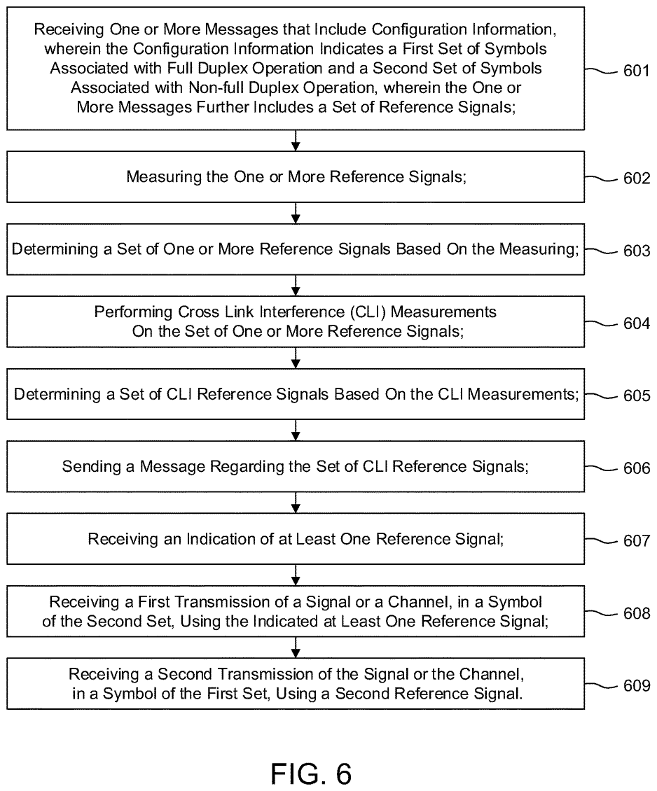

FIG. 6 illustrates an example process regarding beam reference signal restrictions on symbols for full duplex operation. At 601, a WTRU may receive one or more messages that include configuration information, wherein the configuration information indicates a first set of symbols associated with full duplex operation and a second set of symbols associated with non-full duplex operation, wherein the one or more messages further includes a set of reference signals. At 602, the WTRU may measure the one or more reference signals. At 603, the WTRU may have determine a set of one or more reference signals based on the measuring. At 604, the WTRU may perform cross link interference (CLI) measurements on the set of one or more reference signals. At 605, the WTRU may determine a set of CLI reference signals based on the CLI measurements. At 606, the WTRU may send a message regarding the set of CLI reference signals. At 607, the WTRU may receive an indication of at least one reference signal. At 608, the WTRU may receive a first transmission of a signal or a channel, in a symbol of the second set, using the indicated at least one reference signal. At 609, the WTRU may receive a second transmission of the signal or the channel, in a symbol of the first set, using a second reference signal. In some instances, the signal or channel is a configured-grant (CG) PDSCH, semi-persistent-scheduling (SPS) PDSCH. In some instances, the report is sent based on the CLI measurements meeting a threshold. In some instances, an initial report regarding the set of one or more reference signals prior to performing the CLI measurement. In some instances, the message further comprises the second reference signal associated with one of the set of CLI reference signals.

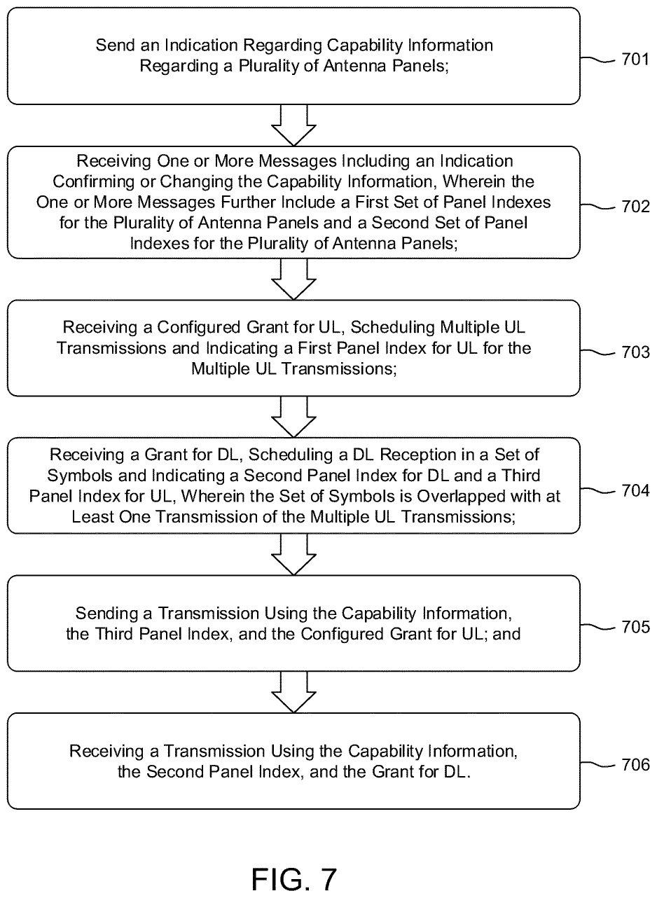

FIG. 7 illustrates an example process regarding link direction management across multiple WTRU panels and dynamic panel mapping/paring for full duplex operation. At 701, a WTRU may send an indication regarding capability information regarding a plurality of antenna panels. At 702, the WTRU may receive one or more messages including an indication confirming or changing the capability information, wherein the one or more messages further include a first set of panel indexes for the plurality of antenna panels and a second set of panel indexes for the plurality of antenna panels. At 703, the WTRU may receive a configured grant for UL, scheduling multiple UL transmissions and indicating a first panel index for UL for the multiple UL transmissions. At 704, the WTRU may receive a grant for DL, scheduling a DL reception in a set of symbols and indicating a second panel index for DL and a third panel index for UL, wherein the set of symbols is overlapped with at least one transmission of the multiple UL transmissions. At 705, the WTRU may send a transmission using the capability information, the third panel index, and the configured grant for UL. At 706, the WTRU may receive a transmission using the capability information, the second panel index, and the grant for DL. In some instances, the grant includes resource assignments relative to the capability information, including symbol information for a specific antenna panel. In some instances, the capability information includes an association between an UL or a DL capability of each of the plurality of antenna panels. In some instances, the grant for DL may include an indication of the first set of panel indexes and the second set of panel indexes.

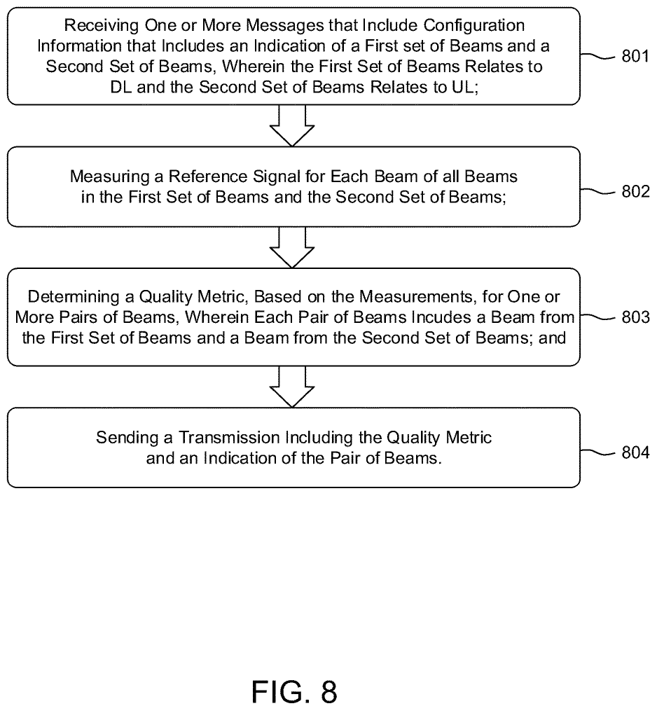

FIG. 8 illustrates an example of process of group-based reporting framework for full duplex capable WTRU. At 801, a WTRU may receive one or more messages that include configuration information that includes an indication of a first set of beams and a second set of beams, wherein the first set of beams relates to DL and the second set of beams relates to UL. At 802, the WTRU may measure a reference signal for each beam of all beams in the first set of beams and the second set of beams. At 803, the WTRU may determine a quality metric, based on the measurements, for one or more pairs of beams, wherein each pair of beams includes a beam from the first set of beams and a beam from the second set of beams. At 804, the WTRU may send a transmission including the quality metric and an indication of the pair of beams. In some instances, the configuration information further includes TCI information for each beam. In some instances, the WTRU may have the means for receiving an indication to simultaneously transmit and receive using the indicated pair of beams. In some instances, the quality metric is based on RSRP and SINR of a given measured reference signal.

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’may imply ‘A and/or B’.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, description associated with/before/after a figure etc.), one of ordinary skill in the art will appreciate that each feature or element is intended be used as presented, alone, or in any combination with the other features and elements disclosed herein without regard to the particular combination as explicitly described. For example, as disclosed herein there may be a method described in association with a figure for illustrative purposes, and one of ordinary skill in the art will appreciate that one or more features or elements from this method may be used alone or in combination with one or more features from another method described in a different figure. For example, it is intended that one or more elements from the methods illustrated in FIGS. 5, 6, 7, and/or 8 may be omitted, may be swapped, replaced, or combined with any one or more other elements as described herein (e.g., with respect to FIGS. 5, 6, 7, and/or 8).

A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit receive unit (WTRU), the method comprising:
sending an indication of capability information regarding a respective directional usage of each of a plurality of antenna panels of the WTRU;
receiving one or more messages including an indication confirming or changing a directional usage of one or more of the plurality of antenna panels of the WTRU, wherein the one or more messages further include a first set of panel indexes for the plurality of antenna panels of the WTRU and a second set of panel indexes for the plurality of antenna panels of the WTRU;
receiving a grant for Downlink (DL) and Uplink (UL), wherein the grant indicates using a first panel index of the first set of panel indexes for the DL and a first panel index of the second set of panel indexes for the UL, wherein the grant further indicates that the grant is applicable only a specific time or for a duration of time;
sending a transmission according to the grant for UL; and
receiving a transmission according to the grant for DL.

2. The method of claim 1, wherein the respective directional usage for at least one of the antenna panels of the plurality of antenna panels is DL, UL, or both DL and UL.

3. The method of claim 1, wherein the directional usage of the first panel index of the first set of panel indexes includes DL, and the directional usage of the first panel index of the second set of panel indexes includes UL.

4. The method of claim 1, wherein the one or more messages is included in a configuration message.

5. The method of claim 1, wherein the one or more messages is a downlink control information, a Medium Access Control (MAC) Control Element (CE) message, or an Radio Resource Control (RRC) message.

6. The method of claim 1, wherein at least one symbol of the grant for the UL is used for the transmission.

7. The method of claim 1, wherein at least one symbol of the grant for the DL that overlaps with the at least one symbol of the grant for the UL is used for the transmission.

8. A wireless transmit receive unit (WTRU), the WTRU comprising:
a processor operatively coupled to a transceiver,
the processor and transceiver configured to send an indication of capability information regarding a respective directional usage of each of a plurality of antenna panels of the WTRU;
the processor and transceiver configured to receive one or more messages including an indication confirming or changing the directional usage of one or more of the plurality of antenna panels of the WTRU, wherein the one or more messages further include a first set of panel indexes for the plurality of antenna panels of the WTRU and a second set of panel indexes for the plurality of antenna panels of the WTRU;
means the processor and transceiver configured to receive a grant for Downlink (DL) and Uplink (UL), wherein the grant indicates using a first panel index of the first set of panel indexes for the DL and a first panel index of the second set of panel indexes for the UL, wherein the grant further indicates that the grant is applicable only a specific time or for a duration of time;
the processor and transceiver configured to send a transmission according to the grant for UL; and
the processor and transceiver configured to receive a transmission according to the grant for DL.

9. The WTRU of claim 8, wherein the respective directional usage for at least one of the antenna panels of the plurality of antenna panels is DL, UL, or both DL and UL.

10. The WTRU of claim 8, wherein the directional usage of the first panel index of the first set of panel indexes includes DL and the directional usage of the first panel index of the second set of panel indexes includes UL.

11. The WTRU of claim 8, wherein the one or more messages is included in configuration message.

12. The WTRU of claim 8, wherein the one or more messages is a downlink control information, a Medium Access Control (MAC) Control Element (CE) message, or an Radio Resource Control (RRC) message.

13. The WTRU of claim 8, wherein at least one symbol of the grant for the UL is used for the transmission is sent.

14. The WTRU of claim 8, wherein at least one symbol of the grant for the DL that overlaps with the at least one symbol of the grant for the UL is used for the transmission.
